(19) United States
(12) Patent Application Publication
(10) Pub. No.: US 2016/0223852 A1
(43) Pub. Date: Aug. 4, 2016

(54) LIQUID CRYSTAL DISPLAY DEVICE

(71) Applicant: NLT TECHNOLOGIES, LTD., Kawasaki (JP)

(72) Inventors: Hideki NISHIMURA, Kanagawa (JP); Kazuyuki SAITO, Kanagawa (JP)

(73) Assignee: NLT TECHNOLOGIES, LTD., Kawasaki (JP)

(21) Appl. No.: 15/009,891

(22) Filed: Jan. 29, 2016

(30) Foreign Application Priority Data
Jan. 30, 2015 (JP) 2015-017766

(51) Int. Cl. G02F 1/1333; F21V 8/00

(52) U.S. Cl. CPC G02F 1/133308; G02B 6/0068; G02B 6/0085; G02F 2001/133317

(57) ABSTRACT

A liquid crystal display device includes: a liquid crystal panel; a light source unit; a chassis which holds the both; and a front frame which holds circumference of the front face side of the liquid crystal panel. The light source unit includes: a light guiding plate which outputs surface light; a light emitting body mounting board provided to the light guiding plate to hold a plurality of LEDs; and a rear frame having a light reflecting function and mounted to the back face side of the light guiding plate. The light source unit reinforcing plate is provided at least to the outer face of the rear frame, and the end part of the light source unit reinforcing plate on the light emitting body mounting board side is bent along the end part of the light guiding plate to be abutted against the light emitting body mounting board.

### CROSS-REFERENCE TO RELATED APPLICATION

This application is based upon and claims the benefit of priority from Japanese patent application No. 2015-017766, filed on Jan. 30, 2015, the disclosure of which is incorporated herein in its entirety by reference.

### BACKGROUND OF THE INVENTION

1. Field of the Invention

The present invention relates to a liquid crystal display device. More specifically, the present invention relates to a liquid crystal display device that is provided with a function which eliminates color unevenness and luminance non-uniformity of a liquid crystal panel through effectively avoiding in advance distortion and deflection of a frame caused by an external force caused by deterioration in the rigidity of the liquid crystal display device due to increase in the size and decrease in the thickness of the display device.

2. Description of the Related Art

Conventionally, an edge light-source type backlight provided to the liquid crystal display device includes a plurality of light emitting elements (light sources) such as LEDs or the like on one side or two sides of a transparent light guiding plate that includes a reflection film on its back face. Further, the light guiding plate is structured to disperse the light from the light source making incident from the side faces and output it towards a liquid crystal screen (liquid crystal panel).

Recently, there is an increasing demand for achieving high luminance with the above-described liquid crystal display device in accordance with its decrease in the thickness and narrowed frame as well as increase in the size. At the same time, the heat generation amount of the light source is increased for achieving high luminance, so that a measure to be taken for the heat of the light source is one of the critical issues.

In that case, reduction in the thickness of the display device mentioned above is executed by decreasing the thickness of each structural member, particularly decreasing the thicknesses of the attaching member of the LED of the light source and the light guiding plate. Thus, reduction in the thickness of each of the structural members inevitably results in deteriorating the rigidity of the entire liquid crystal module.

As a result, the chassis (casing, framework) and the frame for supporting the liquid crystal module become weakened. Thus, the chassis and the frame as a whole may be distorted, deflected, or twisted to be easily deformed. Deformation of the structural members constituting the skeleton is transferred to the liquid crystal panel itself that is mounted therein, thereby causing such inconveniences that non-uniformity in the color (color unevenness) within the display surface and non-uniformity in the luminance (in-surface unevenness) within the display surface is likely to occur.

Note here that there are various kinds of issues that are generated due to decrease in the thickness and increase in the size of the liquid crystal display device. Considering deterioration in the rigidity of the liquid crystal module in particular, there are devices depicted in Patent Documents in the followings as various kinds of liquid crystal display devices having structures for supplementing the deterioration.

Among those, Japanese Unexamined Patent Publication 2006-110623 (Patent Document 1) relates to a reform device of a plasma television chassis 101 shown in FIG. 8, for example. This is designed to execute the reform work of the chassis 101 quickly, securely, and effectively.

In this case, as the chassis 101, the inside of a square panel is protruded to the outer side by performing raising processing while keeping a four peripheral end part 102 remained to form a square recessed part 103 as shown in FIG. 8. Three lateral reinforcing crosspieces 105, and two vertical reinforcing crosspieces 106, for example, are formed within the recessed part 103 in a ladder form and fixed thereto. In addition, the entire chassis 101 is to be reformed based on the distortion amount generated in each of a plurality of regions (symmetrical positions) in this case shown by reference numeral 107.

Further, Japanese Unexamined Patent Publication 2013-125593 (Patent Document 2) is designed to increase the rigidity against distortion of each chassis (frame member 201) that is provided to an edge-light type lighting device, a display device, or a receiving device (see FIG. 9, FIG. 10).

In this case, referring to FIG. 9, the frame member 201 is formed in a rectangular form by two relatively long frame members 211, 212 facing with each other and two relatively short frame members 213, 214 facing with each other. Further, each of a plurality of LEDs 210a, 210a, - - - is provided on the opposing faces of the relatively short frame members 213, 214. A light guiding plate (reference numeral 215 in FIG. 10) for converting the light generated from each of the LEDs 210a into a surface emission light is fitted into the frame member 201. Thereby, the lighting device (corresponds to reference numeral 210 in FIG. 10) is formed.

Also, in the frame member 201, two reinforcement members 231, 232 are placed further at an equivalent interval between the relatively long frame members 211, 212. Thereby, the rigidity of the frame member 201 against distortion is increased.

A frame member 202 which is different in shape but functions equivalently with the frame member 201 of FIG. 9 is also disclosed in FIG. 10. Note here that reference numeral 200 shows a liquid crystal display device, reference numeral 200A shows a liquid crystal panel, and reference numeral 200B shows an attaching frame (bezel) of the liquid crystal panel.

Further, Japanese Unexamined Patent Publication 2000-275445 (Patent Document 3) relates to a light guide and an electro-optical device which is provided with that. As shown in FIG. 11, a technique regarding specifically a liquid crystal panel and a backlight (panel supporting body 301) for lighting the liquid crystal panel from the back side is disclosed.

In the panel supporting body 301 of Patent Document 3, specifically a light guide 302 including a light guiding part 302A which converts light guided from the side face into surface light and outputs it is mounted. In order to protect the light guide 302 and eliminate deformation thereof, the rigidity of the panel supporting body 301 is reinforced (see FIG. 11).

That is, as described above, disclosed in Patent Document 3 shown in FIG. 11 is the panel supporting body 301 which is thin in its vertical direction with respect to the display surface and includes the light guide for the liquid crystal panel that is highly resistant to an impact and the like. It is a feature that protruded rib type thickened reinforcement members 301A and 301B are provided on a diagonal line. This provides an advantage that the panel supporting body 301 is not easily deformed even when an external force such as an impact is applied. Note here that a reference numeral 303 shows a light reflection plate.

Further, Japanese Unexamined Patent Publication 2009-206062 (Patent Document 4) discloses a technique related to a surface and thin type lighting device (see FIG. 12A).

A lighting device 400 according to Patent Document 4 has such an issue that a casing 401 becomes bent. To deal with the issue, Patent Document 4 has a feature in the point that reinforcement members 402A and 402B are separately provided at two areas with a specific space provided therebetween. Thereby, the device is formed as a structure which has a heat dissipating function, a light reflecting function, and an electronic component protecting function (see FIG. 12A).

Specifically, as shown in FIG. 12A, the two reinforcement members 402A and 402B are provided to a back face 401a of the casing 401 from one side to the opposing other one side in parallel to each other.

The two reinforcement members 402A and 402B are formed with a metal plate member with U-shaped cross-section, which can prevent bending caused by the load of the electronic components and the like housed inside the casing 401 from the back face 401a side. Further, each of the reinforcement members 402A and 402B also functions as a heat dissipation member that dissipates the heat emitted from the LEDs (not shown) and transmitted to the casing 401 side.

Furthermore, Japanese Unexamined Patent Publication 2008-91275 (Patent Document 5) discloses a technique regarding a lighting unit and a liquid crystal display device, particularly a technical content for improving the workability when mounting, on the casing 505, an LED board 502 on which a plurality of light emitting diodes (LEDs) 501a, 501a, —are mounted on a same line and for decreasing the number of failures (see FIG. 12B).

Specifically, a technical structure with which a reinforcement member 504 is attached to the LED mounting board 502 and the reinforcement member 504 also includes a function of dissipating the heat of the LEDs 501a. Note here that a reference numeral 506 shows a light guiding plate.

However, each of Patent Documents 1 to 5 described above includes technical measures for reinforcing the rigidity that is weakened in accordance with reduction in the thickness of the entire display devices from inside. However, regarding the preparations for external forces, those disclosed in Patent Documents other than Patent Document 3 are not necessarily sufficient.

Further, along with decrease in the thickness or increase in the size of the entire device, there is a fact that the heat generation amount is increased in accordance with increase in the luminance of the light source. However, each of the exemplary embodiments of above-described Documents is not necessarily sufficient for improving the cooling efficiency.

That is, among each of Patent Documents 1 to 5 described above, Patent Document 1 discloses no effective heat dissipating or cooling technique regarding the heat generated by the display device itself and no measure is taken, either.

Further, Patent Document 2 discloses a fact that the reinforcement members 231 and 232 may be used as heat dissipation members of the LEDs. However, no effective heat dissipating technique or cooling technique is disclosed regarding how the heat is dissipated to the outside via the reinforcement members 231 and 232.

Further, while Patent Document 3 discloses a fact that the panel supporting body 301 becomes hard to be deformed even when an external force such as an impact is applied, there is no disclosure or even indication regarding an effective heat dissipating or cooling technique for the heat radiated from the light emitting diodes.

Furthermore, Patent Document 4 discloses a fact that the reinforcement members 402A and 402B also function as the heat dissipation members for dissipating the heat emitted from the LEDs and transmitted to the casing 401 but does not disclose anything about the positional relation with respect to the light source and the uniformity and the like of the brightness. Further, the disclosed reinforcement members 402A and 402B are narrow-width stick type plate members, which cannot expect an effective heat dissipation effect according to the abutting area.

Furthermore, while Patent Document 5 discloses the technical structure with which the reinforcement member 504 is attached to the LED mounting board 502 and the reinforcement member 504 also functions to dissipate the heat of the LED 501, the reinforcement member 504 is simply mounted by being superimposed on a part of a frame member 506 of a light guiding plate 505 (see FIG. 12B)

Therefore, the heat dissipating function for the LED 501 in Patent Document 5 is equivalent to the slight heat dissipating function of the already well-known frame, and no specific heat dissipating means for the LED 501 is disclosed.

As described, although the conventional techniques of each of the above-described Patent Documents 1 to 5 disclose the entire reinforcement structure regarding the liquid crystal display device or the lighting device thereof, no specific and clear technique regarding the heat dissipation structure for effectively dissipating the heat of the light emitting element (LED) is disclosed in any of those Patent Documents.

It is therefore an exemplary object of the present invention to improve the shortcomings of the conventional techniques and to provide especially a liquid crystal display device which can effectively dissipate the heat generated by light emitting elements and improve the rigidity of the entire device even when the thickness of the entire device is decreased.

### SUMMARY OF THE INVENTION

In order to achieve the foregoing object, the liquid crystal display device according to an exemplary aspect of the invention is a liquid crystal display device which includes: a liquid crystal panel; a light source unit provided on a back face side of the liquid crystal panel; a chassis which holds a peripheral edge part of the light source unit together with the liquid crystal panel; and a front frame which holds circumference on a front face side of the liquid crystal panel together with the chassis, wherein: the light source unit is structured by including a light guiding plate which outputs surface light towards the liquid crystal panel, a light emitting body mounting board which holds a plurality of light emitting elements which are disposed by opposing to an end face of an end part of the light guiding plate, and a rear frame which holds the light guiding plate on a back face side and is provided with a light reflecting function; and a light source unit reinforcing plate is provided on an outer face of the rear frame by corresponding to a part of the light guiding plate, and an end part of the light source unit reinforcing plate on the light emitting body mounting board side is bent along the end face of the light guiding plate and abutted against the back face side of the light emitting body mounting board to be in an integrated structure.

The present invention is structured in the manner described above. This makes it possible to provide a liquid crystal display device in which a light source unit reinforcing plate and a rear frame effectively function to improve the rigidity of the entire device in an associated manner even when the thickness of the entire device is decreased, and the light source unit reinforcing plate and the rear frame effectively disperse and dissipate the heat generated by the light emitting element in an associated manner.

### BRIEF DESCRIPTION OF THE DRAWINGS

FIGS. 1A and 1B show perspective views of a first exemplary embodiment of a liquid crystal display device according to the present invention, in which FIG. 1A is an elevational perspective view showing a liquid crystal panel side (front side) and FIG. 1B is a back-face perspective view showing a bottom face side (back face side) of FIG. 1A;

FIG. 2 is a partially omitted detailed perspective view of the liquid crystal display device disclosed in FIG. 1 viewed from the back face side;

FIG. 3 is a fragmentary cross-sectional perspective view including a part of a section taken along line A-A of FIG. 1B;

FIG. 4 is a fragmentary cross-sectional view including a part of a section taken along line A-A of FIG. 1B;

FIGS. 5A and 5B show diagrams of an example of the effect of the first exemplary embodiment disclosed in FIG. 1, FIG. 5A shows a fragmentary cross-sectional view equivalent to FIG. 4, and FIG. 5B is a chart showing the changing amount of the rigidity of the rear frame part for an external force by using symbols h and t shown in FIG. 5A;

FIG. 5C is a diagram showing an example of the effect of the first exemplary embodiment which is a perspective view showing a light emitting body mounting board to which LEDs are mounted;

FIG. 6 is a fragmentary cross-sectional perspective view showing a second exemplary embodiment of the liquid crystal display device according to the present invention;

FIG. 7 is a fragmentary cross-sectional perspective view showing a third exemplary embodiment of the liquid crystal display device according to the present invention;

FIG. 8 is an explanatory diagram showing an example of a chassis part of a plasma display device (Patent Document 1) as a related technique;

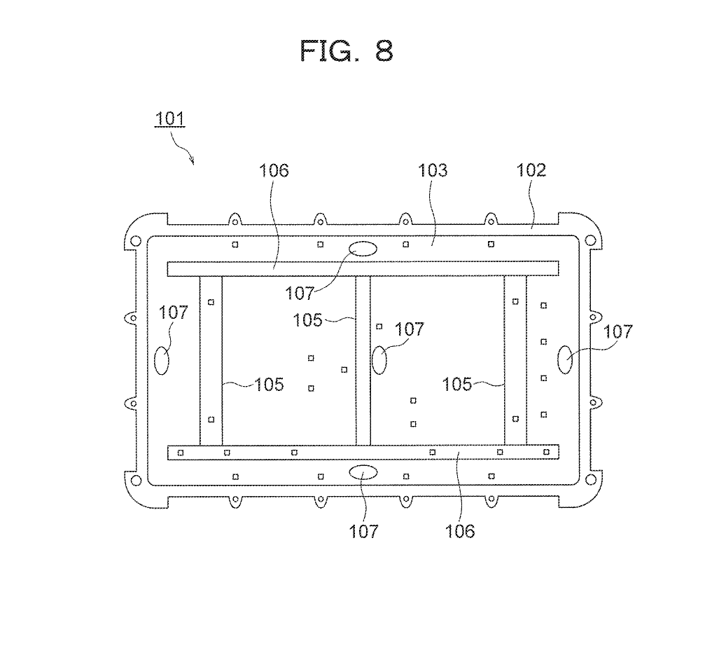

FIG. 9 is an explanatory chart showing an example of a chassis part of an edge light type lighting device (Patent Document 2) as a related technique;

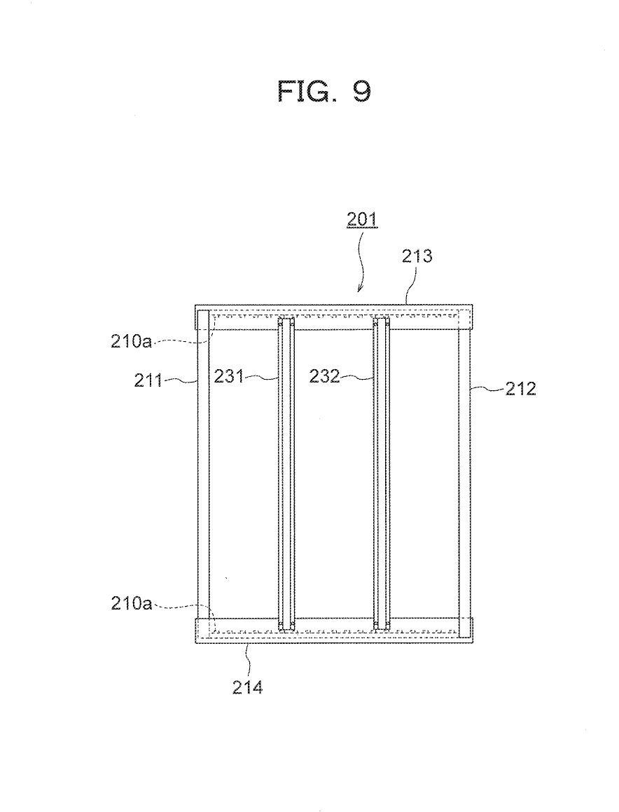

FIG. 10 is a detailed perspective view of a liquid crystal display device (Patent Document 2) to which the lighting device of the related technique shown in FIG. 9 is mounted;

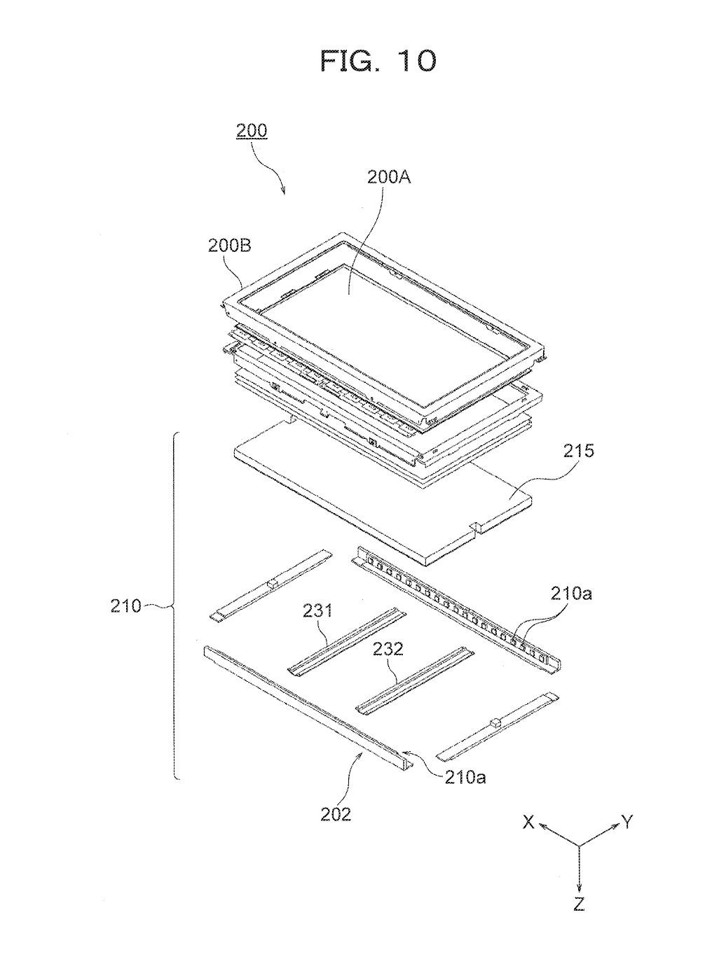

FIG. 11 is a back-face perspective view showing an example of a lighting device (Patent Document 3) of a liquid crystal display device as a related technique; and

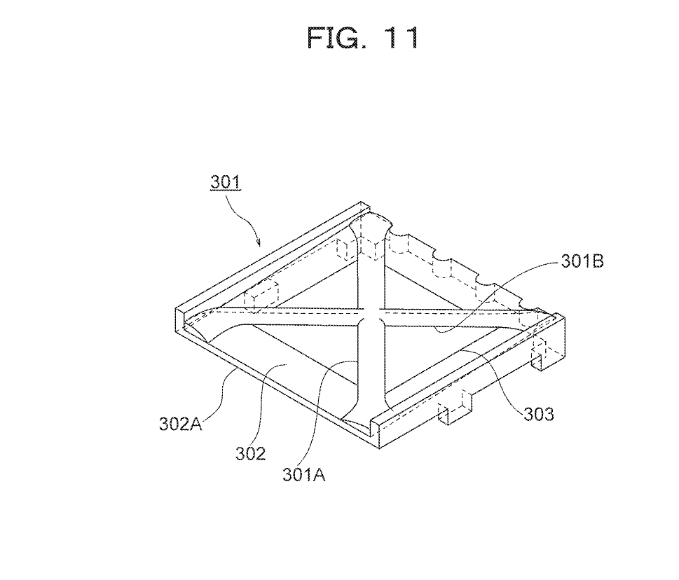

FIGS. 12A and 12B show back-face perspective views of an example of a lighting device of a liquid crystal display device as a related technique, in which FIG. 12A is a back-face perspective view showing an example of a lighting device disclosed in Patent Document 4 and FIG. 12B is a back-face detailed perspective view showing an exemplar of a lighting device disclosed in Patent Document 5.

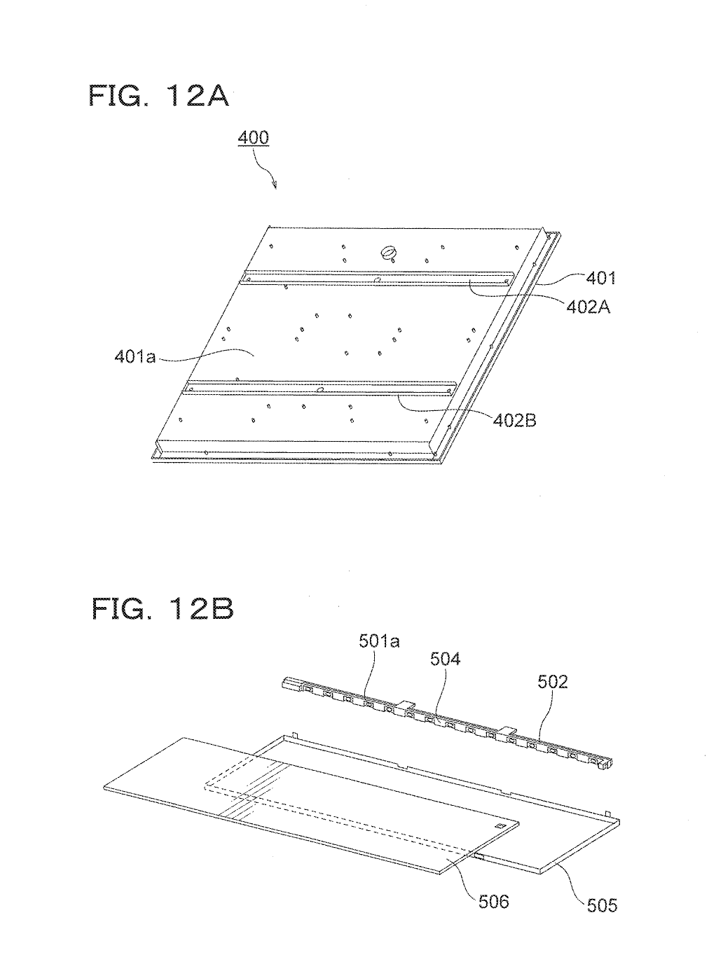

### DETAILED DESCRITPION OF THE PREFERRED EMBODIMENTS

### First Exemplary Embodiment

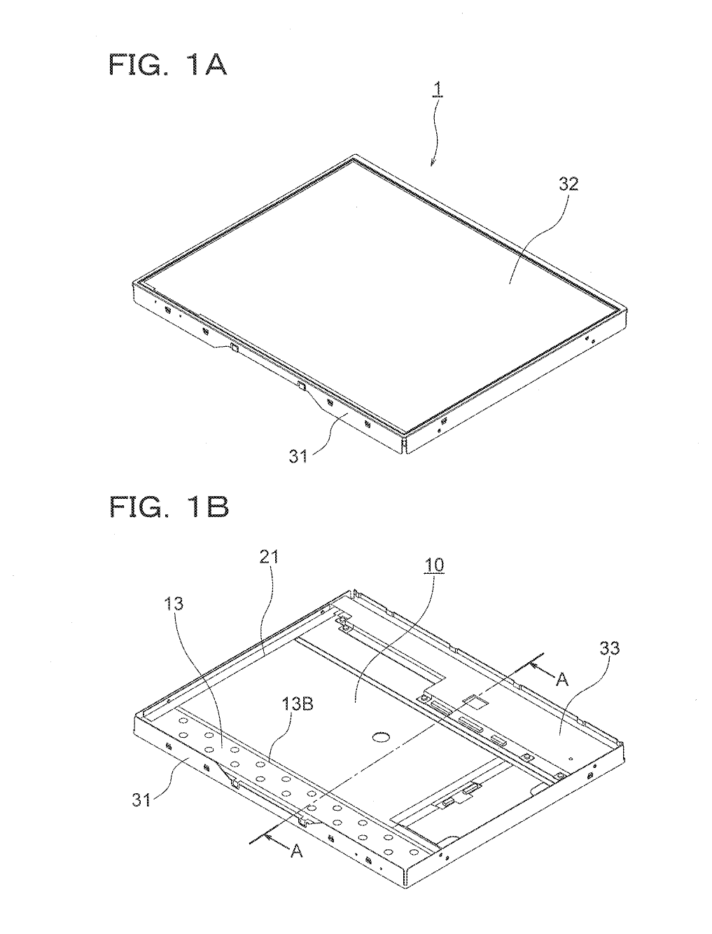

Hereinafter, a first exemplary embodiment according to a liquid crystal display device of the present invention will be described by referring to FIG. 1 to FIG. 5.

### Overall Structures

First, the structures as a whole including the main point of the first exemplary embodiment will be described.

Referring from FIG. 1 to FIG. 5, the liquid crystal display device 1 includes: a liquid crystal panel 32; a plate type light source unit (surface light emitting device) 10 for the liquid crystal panel provided on the back face side of the liquid crystal panel 32; a chassis 25 which holds the peripheral edge part of the light source unit 10 along with the liquid crystal panel 32; and a front frame 31 which holds the circumference on the front side of the liquid crystal panel 32 together with the chassis 25.

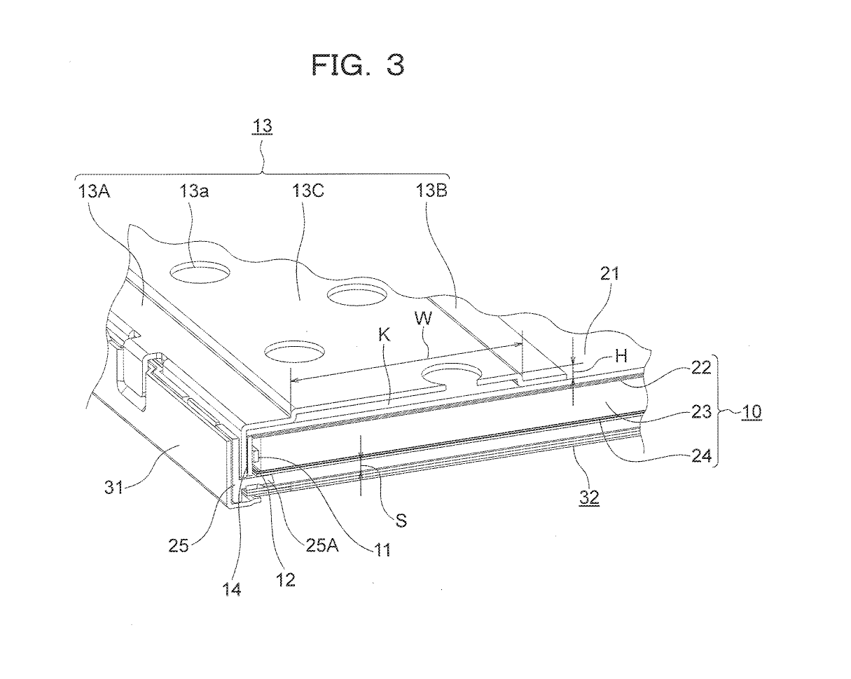

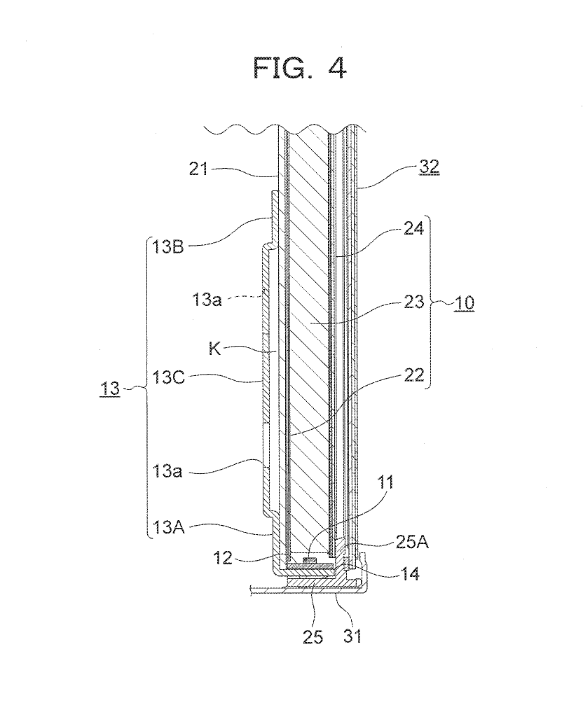

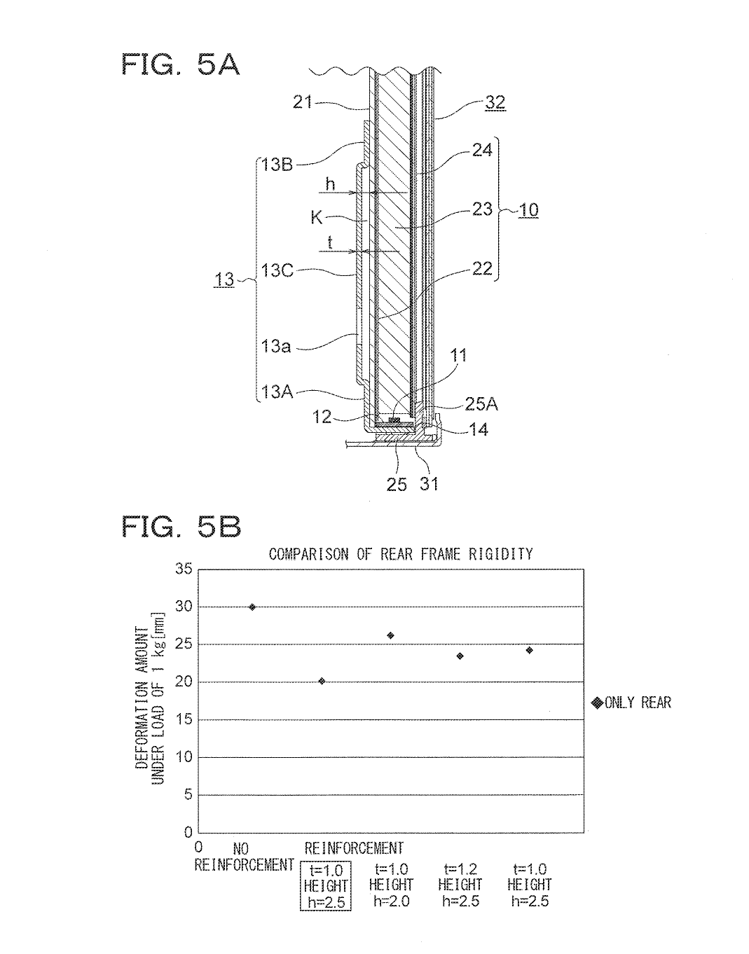

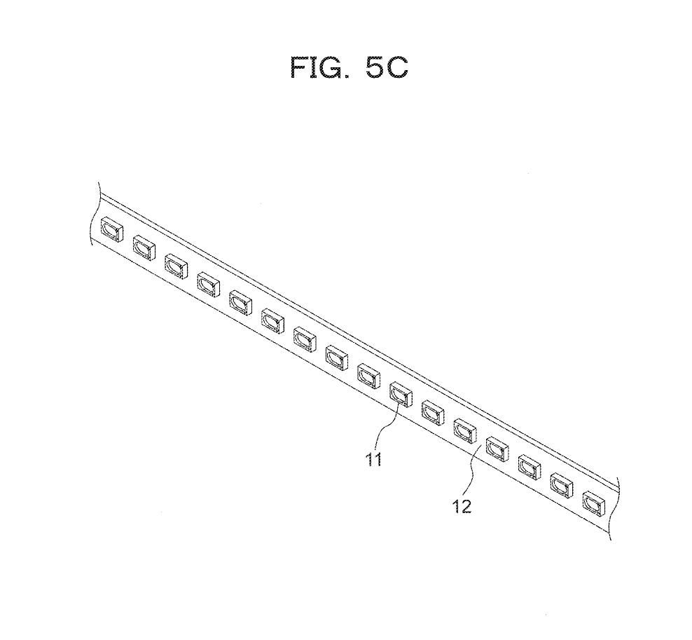

Note here that the light source unit 10 is structured by including: a light guiding plate 23 which outputs surface light towards the liquid crystal panel 32; LED (Light Emitting Diode) light sources (referred to as LED hereinafter) 11 that are a plurality of light emitting elements disposed by opposing to the side end face on one side (one end part) of the light guiding plate 23; a light emitting body mounting board 12 which holds the LEDs 11 sequentially at equivalent intervals as shown in FIG. 5C; a rear frame 21 having a light reflecting function, which is provided on the back face side of the light guiding plate 23 to hold the light guiding plate 23; and an optical sheet 24 which is mounted to the liquid crystal panel 32 side of the light guiding plate 23 (see FIG. 3, FIG. 4).

In this case, a light reflection sheet 22 is provided to the rear frame 21 part on the back face side of the light guiding plate 23 as shown in FIG. 3. Thereby, the rear frame 21 can execute the light reflecting function for the light guiding plate 23. Further, the optical sheet 24 is provided to the liquid crystal panel 32 side of the light guiding plate 23 so that the illuminated light can be efficiently fed towards the liquid crystal panel 32.

Note here that plate type projection parts 25A are provided on the inner face side of the chassis 25 in parallel to the light guiding plate 23. The projection part 25A has a function of simultaneously holding the light guiding plate 23 and the liquid crystal panel 32. In the first exemplary embodiment, the projection parts 25A are provided on the pair of the opposing inner edge-wall faces of the chassis 25, respectively (see FIG. 3, FIG. 4).

In this case, the back face side of the liquid crystal panel 32 is held by the projection parts 25A of the chassis 25, the top face side periphery thereof is held by the front frame 31, and the liquid crystal panel 32 is sandwiched between the both.

Further, the end part of the light guiding plate 23 opposing to the face (light output face side) of the liquid crystal panel 32 side is fixed by the projection parts 25A of the chassis 25 and the back face side (light reflection face side) thereof is fixed by the front frame 31, respectively. At the same time, the light guiding plate 23 is sandwiched between the both independently from the liquid crystal panel 32 described above.

Thus, the light source unit 10 to which the light guiding plate 23 is mounted, for example, is mounted to the liquid crystal display device 1 in a freely detachable manner while being independent from the liquid crystal panel 32.

On the outer face of the rear frame 21, as shown in FIG. 3 to FIG. 4, a light source unit reinforcing plate 13 is mounted by corresponding to a part of the light guiding plate 23. The light source unit reinforcing plate 13 is formed with a rigid member with a fine heat conduction property such as a metal. The end part on the light emission body mounting board 12 side (the tip part of a first terrace part 13A) is bent along the side end face of the light guiding plate 23. Note here that the terrace part indicates a flat face part as shown with reference numerals 13A and 13B. The bent part is provided by being abutted against the back face side of the light emitting body mounting board 12 and integrated by being glued by an adhesive material or a double-sided adhesive tape. Further, the light source unit reinforcing plate 13 is connected to the chassis 25 along with the light emitting body mounting board 12 via the bent part.

Therefore, even when the thickness of the light guiding plate 23 is decreased in accordance with the decrease in the thickness of the entire display device 1, the light source unit reinforcing plate 13 effectively functions to efficiently supplement the strength that may be expected to become insufficient. Thereby, the rigidity of the light guiding plate 23 can be maintained. At the same time, the heat generated by each of the LEDs 11 is simultaneously transmitted to the light source unit reinforcing plate 13 from the whole surface of the light emitting body mounting board 12 and effectively dissipated to the outside via the light source unit reinforcing plate 13.

While the details will be described later, the light source unit reinforcing plate 13 and the rear frame 21 effectively function in an associated manner with the first exemplary embodiment as described above even when the thickness of the entire device is decreased (particularly the thickness of the light guiding plate 23 and the like is decreased). The rigidity of the entire device is improved by using that function. At the same time, the heat generated by each of the LEDs 11 as the light emitting elements can be effectively dispersed and dissipated by the light source unit reinforcing plate 13 and the rear frame 21 functioning in an associated manner.

The light source unit reinforcing plate 13 of the first exemplary embodiment is constituted with: one end region (first terrace part) 13A formed with a surface part whose both ends being abutted against the rear frame 21 and integrally connected thereto and disposed at a position near the LEDs 11, 11, - - - ; the other end region (second terrace part) 13B disposed at a position distant from the LEDs 11, 11, - - - ; and inverted-U-shape cross-sectional flat plate 13C that forms the center region part 13C, which forms a layered space K in a state of being distant from the face of the rear frame 21.

In this case, the layered space K is placed along the layout direction of the LEDs 11, 11, - - - . Further, each of the one end part region 13A and the other end part region 13B of the light source unit reinforcing plate 13 is integrally fixed to the rear frame 21 in a surface-contact manner through screwing, welding, or the like. Thus, the rigidity of the light guiding plate 23 is reinforced along with the rear frame 21.

Thereby, the heat generated by the LEDs 11, 11, - - - is dispersed and transmitted to the light source unit reinforcing plate 13 and the rear frame 21. This makes it possible to improve the heat dissipation effect of the LEDs 11, 11, - - - and, at the same time, to improve the rigidity of the light guiding plate 23 by the light source unit reinforcing plate 13. As a result, the rigidity of the entire device is improved.

Further, a plurality of ventilation holes 13a are formed in the inverted-U-shape cross-sectional flat plate part 13C of the light source unit reinforcing plate 13.

Thereby, the air from an electronic apparatus cooling fan mounted into the liquid crystal display device 1 is blown to the light source unit reinforcing plate 13 and it enters easily inside the layered space K from the plurality of ventilation holes 13a. Thus, the heat on the rear frame 21 side can be cooled as well. Further, the cooling air generates turbulent flows at the plurality of ventilation holes 13a of the light source unit reinforcing plate 13, so that the cooling effect is improved further.

That is, the generated heat transmitted to the rear frame 21 from the LEDs 11, 11, - - - is smoothly discharged to the outside via the ventilation holes 13a, 13a, - - - of the light source unit reinforcing plate 13.

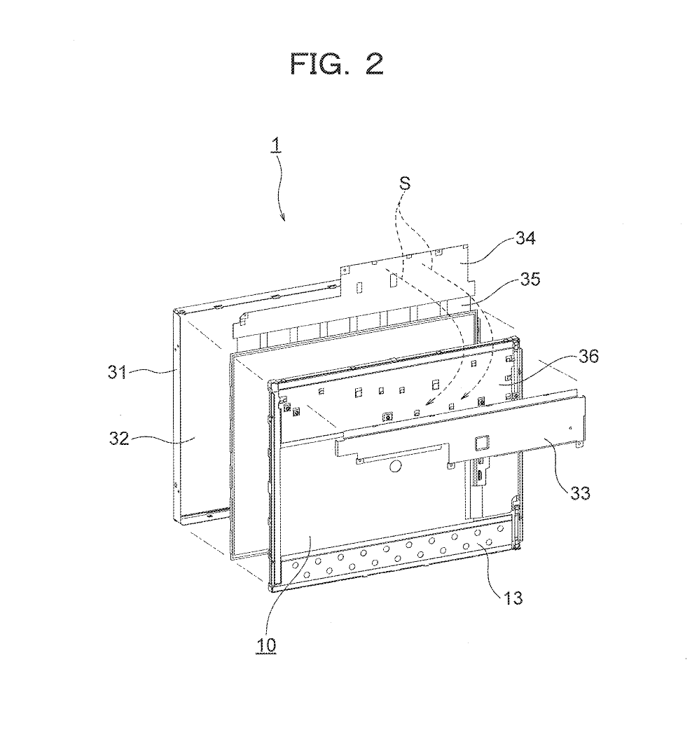

Further, to the liquid crystal panel 32 described above, a signal processing board 34 to which a signal processing circuit used for driving the liquid crystal panel 32 is connected via a flexible board 35 as shown in FIG. 2.

As shown in FIG. 2, the signal processing board 34 is stacked by being bent on the back face side of the light source unit 10 at the flexible board 35 part. Further, it is designed to be integrally superimposed on a signal input/output board 36 that is mounted in advance on the back face side of the light source unit 10. In FIG. 2, dotted lines R show the bending route of the signal processing board 34.

Furthermore, reference numeral 33 shows a board cover that is mounted to the outer face of the signal processing board 34 that is mounted in a superimposing manner.

### (Specific Structures)

Hereinafter, this will be described in a more specific manner.

As described above, the liquid crystal display device 1 according to the first exemplary embodiment includes: the liquid crystal panel 32; the signal processing board 34 that is provided with the signal processing circuit for driving the liquid crystal panel 32; the flexible board 35 such as COF, TCP, or the like, which connects the signal processing board 34 to the liquid crystal panel 32; and the light source unit (backlight) 10 which irradiates light from the back face direction of the liquid crystal panel 32 to project images on the liquid crystal panel 32.

In the light source unit 10, a plurality of LEDs as light emitting elements (light sources) are disposed in advance at least on one side out of the four sides (side end face of the circumference) of the circumference of the light emitting face of the light source unit 10 so that the light makes incident from the side face of the light guiding plate 23 that is formed with a transparent material such as acryl, polycarbonate, or the like. At the same time, the light guiding plate 23 is structured to spread the light on the entire light emission face and outputs it.

In this case, the light guiding plate 23 constituting the so-called edge type backlight includes a reflection pattern with unevenness formed by silk screen printing or molding provided on the back face side thereof so that the light made incident from the light source can be emitted to the light emission face side efficiently. Further, leak of the light towards the outside is prevented by providing the reflection sheet 22 and the like on the side faces and the back face.

A plurality of optical sheets 24 for efficiently allowing the light emitted from the light guiding plate 23 to make incident on the liquid crystal panel 32, such as diffusion sheets, lens sheets, polarization sheets, or the like are attached on the liquid crystal panel 32 side of the light guiding plate 23.

The plurality of LEDs 11 are mounted on the LED mounting board 12 as described above and placed in such a manner that the light emission faces of each of the LEDs 11 oppose to the incident face (side end face) of the light guiding plate 23 at least on one side (side end face) of the light guiding plate 23.

Further, the LED mounting board 12 is attached to the end of the light source unit reinforcing plate 13 that is formed with a metal plate of high heat conductivity such as aluminum for dissipating the heat. As described above, from the view of cross-section, the light source unit reinforcing plate 13 is fixed at the part of the rear frame 21. And the light source unit reinforcing plate 13 is parallel to the fixed part of the rear frame 21, and the light source unit reinforcing plate 13 has the part of bent portion.

Further, regarding the cross-sectional shape of the light source unit reinforcing plate 13, the center region thereof constitutes the inverted-U-shape cross-sectional flat plate part 13C as described above.

That is, the center region of the light source unit reinforcing plate 13 is first bent almost in a right-angle direction so that the first terrace part 13A side slightly leaves from the rear frame 21. Then, it constitutes the parallel part which is in parallel to the rear frame 21 and bent again almost in a right-angle to the rear frame 21 side. Further, it is bent at roughly a right angle at the rear frame 21 to be in contact with the rear frame 21. The regions of the both ends of the light source unit reinforcing plate 13 in contact with the rear frame 21 are defined as the first terrace part 13A and the second terrace part 13B from the LEDs 11 side as described above.

Further, the light source unit reinforcing plate 13 is in contact with the rear frame 21 at the first terrace part 13A and the second terrace part 13B. At the same time, it is fixed to the rear frame 21 via the contact parts through welding, screw-fitting, or nail-fitting.

Thereby, there is the layered space (layered hollow part) K formed between the light source unit reinforcing plate 13 and the rear frame 21 as described above. The light source unit reinforcing plate 13 is in a shape extended, with such cross-sectional shape, to the length corresponding to the length of the LED mounting board 12. Further, as described above, a plurality of the ventilation holes 13a are provided in the flat face part of the light source unit reinforcing plate 13 that is in parallel to the rear frame 21 in the layered space K.

Further, the light source unit reinforcing plate 13 is attached to the LED light incident side of the light guiding plate 23.

The liquid crystal display device 1 includes the light source unit reinforcing plate 13 provided on the back face of the rear frame 21. Further, through providing the layered space K, the rigidity of the rear frame 21 is increased. Thereby, the rigidity of the liquid crystal display device 1 itself is increased.

Further, in a case where the plurality of LEDs 11 and the LED mounting board 12 on which those are mounted are attached on the two sides on top and bottom (opposing two sides) of the light guiding plate 23, the light source unit reinforcing plate 13 and the layered space K formed between the light source unit reinforcing plate 13 and the rear frame 21 are placed in the regions of the two sides on the top and bottom (two opposing sides) that are the light incident parts of the light guiding plate 23.

Further, regarding the heat generated by each of the LEDs 11, the heat of the LEDs 11 is dissipated to the light source unit reinforcing plate 13 via the LED mounting board 12. At the part where the light source unit reinforcing plate 13 is connected to the rear frame 21, the heat of the LEDs is also transmitted to the rear frame 21. Thus, the number of heat transmission paths is increased. Thereby, the heat dissipation effect is increased.

Further, in a case where there are air flows generated by a fan or the like of an electronic apparatus that is mounted to the liquid crystal display device 1, the air flows generate turbulent flows at each of the ventilation holes 13a of the light source unit reinforcing plate 13. The air flows are also generated in the layered space K between the light source unit reinforcing plate 13 and the rear frame 21. Thus, the cooling effect of not only the light source unit reinforcing plate 13 but also of the rear frame 21 is increased, so that the cooling efficiency for each of the LEDs 11 can be improved.

In this case, the more the number of the points fixed between the light source unit reinforcing plate 13 and the rear frame 21 through welding or screws, the more effectively the heat generated by each of the LEDs 11 is transmitted to the rear frame 21. In the first exemplary embodiment, each of the members is formed with a highly conductive material and closely fitted to each other as described above so that the heat generated by each of the LEDs 11 is easily transmitted.

### Actions of First Exemplary Embodiment

Provided that the width W of the layered space K formed between the light source unit reinforcing plate 13 and the rear frame 21 is fixed, the rigidity of the rear frame 21 and the light source reinforcing unit 13 is more increased as the height H becomes higher. Further, regarding the increase in the temperature, the vicinity of each of the LEDs 11 becomes hot. However, since the structure with the improved heat dissipation effect is employed as described above, the increase in the temperatures in the regions of the rear frame 21 and the light guiding plate 23 can be suppressed even when the vicinity of each of the LEDs 11 becomes hot. As a result, thermal deformation of the rear frame 21 and the light guiding plate 23 can be suppressed, and the rigidity of the entire liquid crystal display device 1 can be increased at the same time.

Further, the heat generated by each of the LEDs 11 is transmitted to the light source unit reinforcing plate 13 via the LED mounting board 12, and it is partially divided to the rear frame 21 side at the part integrally abutted against the rear frame 21.

Furthermore, the heat of each of the LEDs 11 is saturated with thermal conduction of about 60-70 mm even with a sheet metal of aluminum or the like in thickness t of 1.0, for example. Thus, the thermal diffusion effect of more than that is small, so the thermal diffusion in the entire rear frame 21 cannot be expected.

Therefore, with the first exemplary embodiment employing the structure in which the heat dissipation module is divided to the two members of the light source unit reinforcing plate 13 and the rear frame 21, the thermal diffusion can be done in each of those. Also, it is expected to improve the efficiency of heat radiation into the air, so that the heat dissipation effect can be improved in that respect. Furthermore, by using the fan and the like mounted to the electronic apparatus, air flows are also generated in the layered space K between the rear frame 21 and the light source unit reinforcing plate 13. This also increases the heat dissipation effect.

### Effects of First Exemplary Embodiment

As described, the rear frame 21 and the light source unit reinforcing plate 13 in the first exemplary embodiment are lighter in weight compared to a case of structuring those with a single plate, and the rigidity in the display screen direction and the direction perpendicular to the display screen can be improved further.

For example, deformation amounts of the rear frame when applying a force of 9.81 N to a corner in a case where the screen was 20-inch in size and side-mounted with diagonal fixing were acquired by analysis.

With the thickness t and the bending height h of the light source unit reinforcing plate shown in FIG. 5A, the deformation amounts of the part to which the force was applied were acquired. The result thereof is put into a graph and shown in FIG. 5B.

According to that, compared to the case having no light source unit reinforcing plate 13, increase in the strength of 1.15 times can be achieved in a case of “t=1.0, h=2.0” and increase of 1.49 times can be achieved in a case of “t=1.0, h=2.5”.

Further, through fixing the light source unit reinforcing plate 13 and the rear frame 21 at the first terrace part 13A, the heat generated from each of the LEDs 11 is separated into two. Thus, the heat dissipation efficiency is improved. Further, due to a convection current generated inside the layered space K, the heat dissipation efficiency is improved still more.

For example, let's look at a case where the screen is 20-inch in size and the power consumption of the light source is 26 W. In a relative comparison made with analyzed values, the thermal resistance of the liquid crystal display device 1 without the light source unit reinforcing plate 13 is 2.76 W°C. In the meantime, by providing the light source unit reinforcing plate, the thermal resistance becomes 2.40 W/°C, which is improvement of 13%. Thereby, an effect of achieving evident improvement in the heat dissipation efficiency can be acquired.

Further, as described above, the light source unit reinforcing plate 13 is provided on the back face of the rear frame 21 in the liquid crystal display device 1 of the first exemplary embodiment. Further, through providing the layered space K, the rigidity of the rear frame 21 and the light guiding plate 23 is increased and, at the same time, the rigidity of the liquid crystal display device 1 itself is improved.

Further, as described above, the heat generated by each of the LEDs 11 is transmitted to the light source unit reinforcing plate 13 and it is transmitted to the rear frame 21 from the light source unit reinforcing plate 13 at the parts where the light source unit reinforcing plate 13 is connected to the rear frame 21. Thereby, the heat dissipation effect is increased.

Furthermore, due to the air flows generated by the fan of the electronic apparatus and the like to which the liquid crystal display device 1 is mounted, the air turbulent flows are generated in the plurality of the holes 13a of the light source unit reinforcing plate 13 while the air flows are also generated in the layered space K between the light source unit reinforcing plate 13 and the rear frame 21. Thus, the cooling effect is increased not only in the light source unit reinforcing plate 13 but also in the rear frame 21. As a whole, the cooling efficiency of the heat generated by the LEDs is improved greatly.

The first exemplary embodiment is structured and functions in the manner described above. Thereby, even in a case where the thickness of each of the structural members is reduced for decreasing the thickness of the entire liquid crystal display device 1, the light source unit reinforcing plate 13 and the rear frame 21 effectively function in an associated manner. Further, the first exemplary embodiment can provide such an advantage that it is possible to improve the rigidity of the entire device (particularly the light guiding plate 23) and, at the same time, to effectively disperse and dissipate the heat generated by each of the LEDs 11 as the light emitting elements by the light source unit reinforcing plate 13 and the rear frame 21 in an associated manner.

### Second Exemplary Embodiment

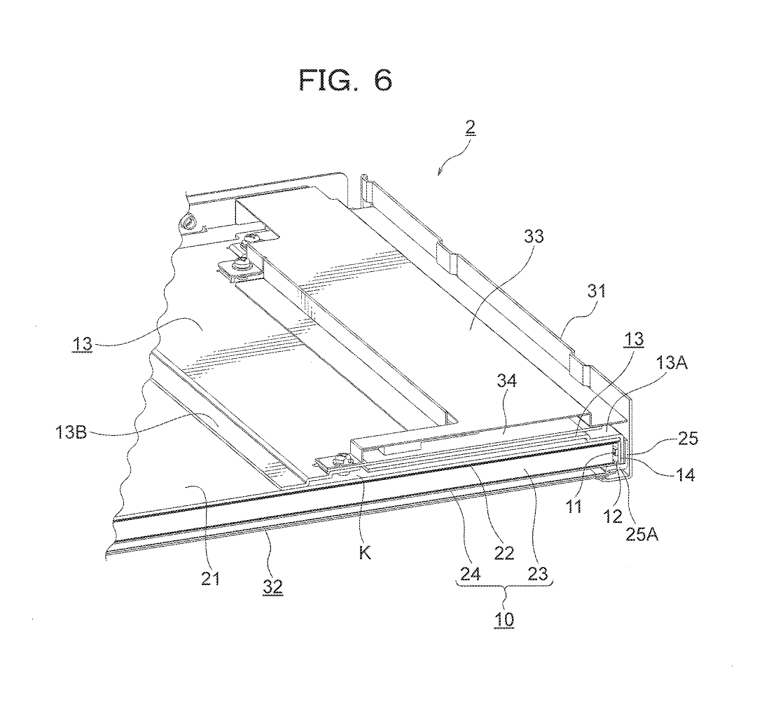

Next, a second exemplary embodiment of the present invention will be described by referring to FIG. 6.

Note here that reference numerals used in the first exemplary embodiment described above are used for each of the structural members.

A liquid crystal display device 2 according to the second exemplary embodiment has a feature in the point that a plurality of LEDs 11, 11, - - - mounted to the light source unit 10, the LED mounting board 12, and the light source unit reinforcing plate 13 are provided on the signal processing board 34 side which drives the liquid crystal panel 32.

That point will be described hereinafter.

Referring to FIG. 6, the light source unit reinforcing plate 13 includes screw holes for fixing the signal processing board 34. The layered space K is provided between the signal processing board 34 and the light source unit reinforcing plate 13 as in the case of the first exemplary embodiment described above.

Further, over (outer face of) the signal processing board 34, the board cover 33 is provided with a prescribed space K3. Since there is the layered space K same as the one described above between the signal processing board 34 and the light source unit reinforcing plate 13, the heat of each of the LEDs 11, 11, - - - transmitted to the light source unit reinforcing plate 13 is prevented from being directly transmitted to the signal processing board 34.

Further, through providing screw parts or hook parts for fixing the signal processing board 34 to the light source unit reinforcing plate 13, it becomes unnecessary to provide holes and the like in the rear frame 21. Thus, the light from the backlight (light guiding plate 23) leaked from the gaps and the like of the rear frame 21 can be shielded.

That is, the well-known liquid crystal display devices output the light from the display screen (bottom face side in FIG. 6), so that the light is also leaked to the back face side from the gaps on the back face in many cases. In a case where the intensity of the light leaked from the back face is high, the light of the back face of the liquid crystal display device may be leaked from the ventilation slits of the electronic apparatus and the like to which the liquid crystal display device is mounted. With the second exemplary embodiment, such issues can be overcome and the light leaked from the back face can be suppressed as much as possible. This point is the same also in the case of the first exemplary embodiment.

Other structures and working effects thereof are the same as the case of the first exemplary embodiment described above.

With the second exemplary embodiment described above, the same working effects as the case of the liquid crystal display device 1 of the first exemplary embodiment described above can be acquired.

### Third Exemplary Embodiment

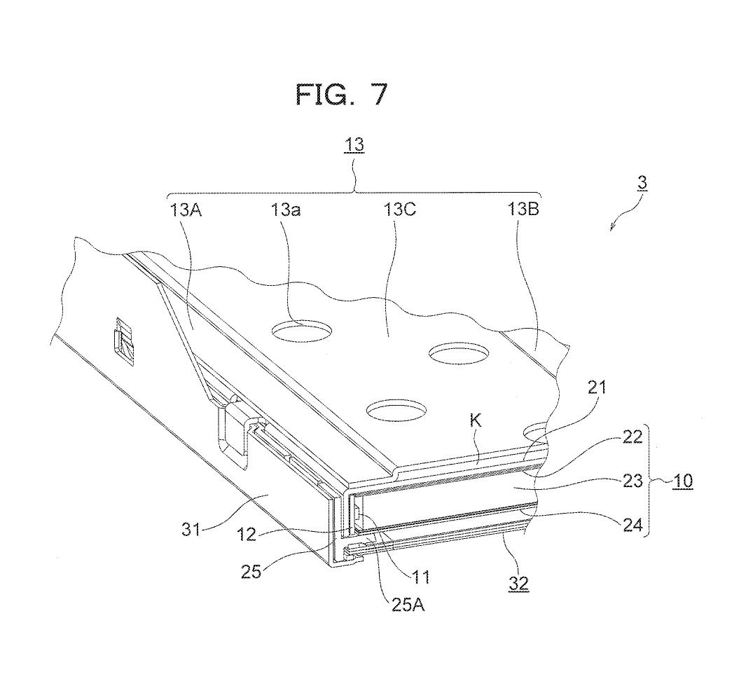

Next, a third exemplary embodiment of the present invention will be described by referring to FIG. 7.

Note here that reference numerals used in the first exemplary embodiment described above are used for each of the structural members.

In each of the first and second exemplary embodiments described above, shown is the case where the LED mounting board 12 is attached to the end part of the light source unit reinforcing plate 13.

In the meantime, the third exemplary embodiment employs the structure similar to that of the first exemplary embodiment.

In this case, the third exemplary embodiment employs the structure in which the LED mounting board 12 is attached to the rear frame 21 by bending it to an L shape at the end part of the light guiding plate 23.

That is, in FIG. 7, the rear frame 21 is bent almost at a right angle towards the liquid crystal panel 32 side, and the LED mounting board 12 is fixed to the face opposing to the side face of the light guiding plate 23 via the double-sided adhesive tape 14 or the like.

The light source unit reinforcing plate 13 is fixed by screws or welding, or the like to the back face of the rear frame 21, and the edge of the light source unit reinforcing plate 13 sets parallel to the direction which is the long-side of the LED mounting board 12.

And the light source unit reinforcing plate 13 has the part of the terrace part 13A and 13B, and the both terrace parts 13A and 13B are perpendicular to the surface of the LED mounting board Further, the light source unit reinforcing plate 13 includes the first terrace part 13A that is formed by being bent almost at a right angle in the direction leaving from the rear frame 21. Furthermore, bending almost at a right angle is repeated so that the light source unit reinforcing plate 13 is bent almost at a right angle in the direction leaving from the LED mounting board 12 to have a face almost in parallel to the rear frame 21, and then to form the second terrace part 13B.

Thereby, as in the cases of the first and second exemplary embodiments described above, the heat generated by each of the LEDs 11 is transmitted to the rear frame 21 via the LED mounting board 12. The heat transmitted from the LED light sources 11 is divided at the first terrace part 13A where the rear frame 21 and the light source unit reinforcing plate 13 come in contact and transmitted to the light source unit reinforcing plate 13.

Further, with the air turbulent flows generated by the layered space K formed by the LED light source unit reinforcing plate 13 and the rear frame 21 as well as the plurality of ventilation holes 13A provided to the light source unit reinforcing plate 13, the rear frame 21 and the light source unit reinforcing plate 13 are cooled.

Other structures and working effects thereof are the same as the case of the first exemplary embodiment described above.

With the third exemplary embodiment described above, the same working effects as the case of the liquid crystal display device 1 of the first exemplary embodiment described above can be acquired.

### Fourth Exemplary Embodiment

Next, a fourth exemplary embodiment of the present invention will be described.

Note here that reference numerals used in the first exemplary embodiment described above are used for each of the structural members.

In each of the first and second exemplary embodiments described above, shown is a case where the light source unit reinforcing plate 13 is fixed to the rear frame 21 through screws, welding, or the like. However, in the fourth exemplary embodiment, the light source unit reinforcing plate 13 is fixed to the rear frame 21 at the first terrace part 13A and the second terrace part 13B through screws or nail fitting.

At the same time, employed is a structure with which the light source unit 10 including the LED mounting board 12 on which a plurality of LEDs 11, 11, - - - are mounted and the light source unit reinforcing plate 13 is detachable from the chassis 25.

Thereby, when the luminance of each LED 11 (LED light source) is deteriorated due to the useable life, the entire LED light sources can be exchanged through exchanging the LED mounting board 12 on which each of the LEDs is mounted. In this case, the light source unit reinforcing plate 13 and the light guiding plate 23 to which the rear frame 21 is attached may be reused.

Other structures and working effects thereof are the same as the case of the first exemplary embodiment described above.

With the fourth exemplary embodiment described above, the same working effects as the case of the liquid crystal display device 1 of the first exemplary embodiment described above can be acquired.

While the present invention has been described by referring to each of the above exemplary embodiments, the present invention is not limited only to the structures and the actions of each of the above-described exemplary embodiments. Regarding the structures and the details of the present invention, various kinds of changes and modifications occurred to those skilled in the art can be applied. Further, the present invention also includes those acquired by combining a part of or a whole part of each of the above-described exemplary embodiments as appropriate.

While a part of or a whole part of the above-described exemplary embodiments can be depicted as following Supplementary Notes, the present invention is not limited only to the following structures.

### (Supplementary Note 1)

A liquid crystal display device which includes:

a liquid crystal panel 32; a light source unit 10 provided on a back face side of the liquid crystal panel 32; a chassis 25 which holds a peripheral edge part of the light source unit 10 together with the liquid crystal panel 32; and a front frame 31 which holds circumference on a front face side of the liquid crystal panel 32 together with the chassis 25, wherein:

the light source unit 10 is structured by including a light guiding plate 23 which outputs surface light towards the liquid crystal panel 32, a light emitting body mounting board 12 which holds a plurality of light emitting elements 11 which are disposed by opposing to an end face of an end part of the light guiding plate 23, and a rear frame 21 which holds the light guiding plate 23 on a back face side and is provided with a light reflecting function; and

a light source unit reinforcing plate 13 is provided on an outer face of the rear frame 21 by corresponding to a part of the light guiding plate 23, and an end part of the light source unit reinforcing plate 13 on the light emitting body mounting board 12 side is bent along the end face of the light guiding plate 23 and abutted against the back face side of the light emitting body mounting board 12 to be in an integrated structure.

### (Supplementary Note 2)

The liquid crystal display device as depicted in Supplementary Note 1, wherein

instead of the end part of the light source unit reinforcing plate 13 on the light emitting body mounting board 12 side, an end part of the rear frame 21 on the light emitting body mounting board 12 side is bent along the end face of the light guiding plate 23 to be abutted against the back face side of the light emitting body mounting board 12.

### (Supplementary Note 3)

The liquid crystal display device as depicted in Supplementary Note 1 or 2, wherein

the light source unit reinforcing plate 13 is constituted with: a first terrace part 13A and a second terrace part 13B with both edge parts thereof being abutted against the rear frame 21 and integrally coupled thereto; and an inverted-U-shape cross-sectional flat plate part 13C which is a layered space K formed on an inner side with a center region part 13C being isolated from the rear frame 21.

### (Supplementary Note 4)

The liquid crystal display device as depicted in Supplementary Note 3, wherein

the light source unit reinforcing plate 13 includes a plurality of ventilation holes 13a in the inverted-U-shape cross-sectional flat plate part 13C.

### (Supplementary Note 5)

The liquid crystal display device as depicted in any one of Supplementary Notes 1 to 4, wherein

a signal processing board 34 which is held to the light source unit reinforcing plate 13 and forms a specific layered space K between with the light source unit reinforcing plate 13 is provided on an outer face side of the light source unit reinforcing plate 13, and a signal processing circuit for driving the liquid crystal panel is mounted to the signal processing board 34.

### (Supplementary Note 6)

The liquid crystal display device as depicted in any one of Supplementary Notes 1 to 5, wherein

the light source unit 10 is mounted to the chassis 25 to be freely detachable along with the light source unit reinforcing plate 13.

What is claimed is:

1. A liquid crystal display device, comprising:
a liquid crystal panel; a light source unit provided on a back face side of the liquid crystal panel; a chassis which holds a peripheral edge part of the light source unit together with the liquid crystal panel; and a front frame which holds circumference on a front face side of the liquid crystal panel together with the chassis, wherein:
the light source unit is structured by including a light guiding plate which outputs surface light towards the liquid crystal panel, a light emitting body mounting board which holds a plurality of light emitting elements which are disposed by opposing to an end face of an end part of the light guiding plate, and a rear frame which holds the light guiding plate on a back face side and is provided with a light reflecting function; and
a light source unit reinforcing plate is provided on an outer face of the rear frame by corresponding to a part of the light guiding plate, and an end part of the light source unit reinforcing plate on the light emitting body mounting board side is bent along the end face of the light guiding plate and abutted against the back face side of the light emitting body mounting board to be in an integrated structure.

2. The liquid crystal display device as claimed in claim 1, wherein
instead of the end part of the light source unit reinforcing plate on the light emitting body mounting board side, an end part of the rear frame on the light emitting body mounting board side is bent along the end face of the light guiding plate to be abutted against the back face side of the light emitting body mounting board.

3. The liquid crystal display device as claimed in claim 1, wherein
the light source unit reinforcing plate is constituted with: a first terrace part and a second terrace part with both edge parts thereof being abutted against the rear frame and integrally coupled thereto; and an inverted-U-shape cross-sectional flat plate part which is a layered space formed on an inner side with a center region part being isolated from the rear frame.

4. The liquid crystal display device as claimed in claim 3, wherein
the light source unit reinforcing plate includes a plurality of ventilation holes in the inverted-U-shape cross-sectional flat plate part.

5. The liquid crystal display device as claimed in claim 1, wherein
a signal processing board which is held to the light source unit reinforcing plate and forms a specific layered space between with the light source unit reinforcing plate is provided on an outer face side of the light source unit reinforcing plate, and a signal processing circuit for driving the liquid crystal panel is mounted to the signal processing board.

6. The liquid crystal display device as claimed in claim 1, wherein
the light source unit is mounted to the chassis to be freely detachable along with the light source unit reinforcing plate.

7. A liquid crystal display device, comprising:
a liquid crystal panel; a light source unit provided on a back face side of the liquid crystal panel; a chassis which holds a peripheral edge part of the light source unit together with the liquid crystal panel; and a front frame which holds circumference on a front face side of the liquid crystal panel together with the chassis, wherein:
the light source unit is structured by including light guiding means for outputting surface light towards the liquid crystal panel, a light emitting body mounting board which holds a plurality of light emitting elements which are disposed by opposing to an end face of an end part of the light guiding means, and rear frame means which holds the light guiding means on a back face side for reflecting light; and
a light source unit reinforcing plate is provided on an outer face of the rear frame by corresponding to a part of the light guiding means, and an end part of the light source unit reinforcing plate on the light emitting body mounting board side is bent along the end face of the light guiding means and abutted against the back face side of the light emitting body mounting board to be in an integrated structure.
